(19) United States
(12) Patent Application Publication
(10) Pub. No.: US 2014/0278499 A1
(43) Pub. Date: Sep. 18, 2014

(54) BLOOD SUPPLY MANAGEMENT SYSTEM

(71) Applicants: Benjamin James Bowman, St. Paul, MN (US); David Mitchell, Minneapolis, MN (US)

(72) Inventors: Benjamin James Bowman, St. Paul, MN (US); David Mitchell, Minneapolis, MN (US)

(73) Assignee: GENERAL BLOOD, LLC, Minneapolis, MN (US)

(21) Appl. No.: 14/211,417

(22) Filed: Mar. 14, 2014

Related U.S. Application Data
(60) Provisional application No. 61/790,630, filed on Mar. 15, 2013.

(51) Int. Cl. G06Q 50/22; G06Q 30/06

(52) U.S. Cl. CPC G06Q 50/22; G06Q 30/0601
USPC 705/2

(57) ABSTRACT

A system and method for managing blood product inventory, acquisition, transport and tracking. Blood centers can collect blood and other biologics and place supply information on a virtual market where hospitals and other healthcare institutions can see available quantities and types, select the amount and type needed, and make a purchase. The system and method enables distribution of blood and other biologics to institutions like hospitals and other healthcare institutions to be more efficient and more consistent in terms of quality and cost.

### CROSS-REFERENCE TO RELATED APPLICATION

This application claims the benefit of U.S. Provisional Application No. 61/790,630 filed Mar. 15, 2013, titled BLOOD SUPPLY MANAGEMENT SYSTEM.

### FIELD

The present invention relates to a system and method for enabling blood product supply and demand to be integrated into a virtual market. It enables blood product distribution to institutions such as hospitals to be more efficient and more consistent in terms of blood quality and cost.

### BACKGROUND OF THE INVENTION

Blood products (red blood cells, plasma, platelets, etc.) are collected from volunteer donors and sold to hospitals for transfusion. Blood products are critical components in healthcare delivery. Blood supplies must be both rapidly available and also cost-effective. For many reasons, these conditions are not currently being met in the marketplace.

Additionally, blood products are usually a significant expense for hospitals, especially in larger metropolitan trauma hospitals. Given that hospitals get reimbursed the same amount of money for a procedure regardless of the amount of blood used, it is in their best interest to use less and pay less for blood. In addition, to reduce costs and complications in patients and, therefore, readmissions, doctors are attempting to use less blood during routine procedures. However, there are natural limits to this reduction in blood use and related cost.

As for supply, there are numerous inefficiencies in the current method of blood ordering, sale and transport, as described below. This creates a supply issue. While red blood cells have a shelf life of 42 days, many doctors believe that fresher blood results in fewer medical complications. Thus, there are additional physician and hospital pressures to improve the just-in-time logistics of collecting, processing and distributing blood. Further, payment is a chronic problem in the industry.

Blood banks manufacture a variety of blood products. However, the most basic products are red blood cells (often leukocyte-reduced), fresh frozen plasma and apheresis platelets. A standard blood donation yields approximately 450-500 ml of blood, of which about 250 ml is separated into plasma by further processing. Apheresis platelets are collected by a different process that takes up to two hours.

Historically, hospitals have had little choice in blood providers, leading to high costs and product shortages. Hospitals are almost completely dependent on local community blood banks and the American Red Cross (ARC) for supplying blood and plasma for transfusion. In order to use blood for transfusion, hospitals require that the blood be from an unpaid “volunteer donor.” The Food and Drug Administration (FDA) defines a volunteer donor as “a person who does not receive monetary payment for a blood donation.” Therefore, the blood banking industry is completely dependent on volunteer donors for supply.

Blood donation centers (the providers of blood products) are regionally-focused in both collection and distribution. 99% of blood centers are operated as not-for-profit, and most do not operate with traditional manufacturing efficiency. Currently, there is not a centralized location where real-time costs and supply levels for blood products throughout the United States are monitored and made available to hospitals for purchase. The closed nature of the market, compounded by the regional focus of the blood centers, results in enormous price and service level discrepancies for blood products to hospitals. For example, the price for a unit of red blood cells varies from $180 (Tennessee) to $375 (New Jersey).

The market for blood products is somewhat sensitive to economic cycles depending on the purpose for which the blood product is needed. Blood needed for elective surgeries is subject to economic cycles. However, blood for trauma use is shielded from economic cycles. Over the past three years, there has been an unprecedented oversupply of blood in the market due to fewer elective procedures and improved patient blood management programs.

There is a great deal of seasonality to the supply of blood. During the December holiday season and over the summer blood donors are preoccupied with other activities. Therefore, the supply of blood decreases during these months while the demand stays relatively stable.

There has been very little technological change in the blood banking industry over the past few decades. The biggest change has been the development of equipment that allows a volunteer to donate two units of red blood cells in one sitting. In addition, there has been increased focus on testing as HIV and other diseases have become more prevalent.

The FDA oversees the blood and plasma industry through the Center for Biologics Evaluation and Research (CBER). The FDA considers blood banks pharmaceutical manufacturers (doctors technically prescribe blood to patients). Most state governments do not oversee or regulate blood banks except for establishing a minimum donor age.

Blood is distributed primarily through the following channels: (1) contracts with hospitals (both exclusive and non-exclusive); (2) blood bank “resource sharing” with other blood banks; and (3) blood brokers.

Blood banks primarily contract with hospitals to supply blood and plasma (for transfusion) on a consistent, perpetual basis. Most contracts are two or three years in length and offer standard pricing across all ABO/Rh blood types. In most cases, hospitals are forced to enter into exclusive supply agreements with blood banks

When a blood bank cannot fulfill a customer request for a specific type or volume of product, it will often call upon another blood bank to supplement its supply. These transactions are based heavily on relationships and are usually conducted inefficiently over the telephone and without the hospital's knowledge such that the hospital is getting blood from an unknown entity with no documentation about this “ghost” blood center's compliance with the FDA, the American Association of Blood Banks (AABB), and other regulatory bodies. Hospitals also are not benefitting from any difference in price there might be between these blood centers.

Blood brokers are authorized by the FDA to broker blood products among blood banks and between blood banks and hospitals. Some brokers actually purchase, store and distribute the blood while others only coordinate the transaction.

Blood banks cannot collect the exact mix of blood types needed to fulfill their contracts and therefore must over-collect to achieve the right product mix. Moreover, blood banks do not turn away donors and therefore sometimes have blood drives that are “too successful.” In both cases, the chance that product will expire and go to waste is high.

Costs to collect donations vary by region due to factors such as overhead structure (levels of management), labor costs, real estate costs, donor density, and donor acquisition costs (marketing). This regional variance imposes additional inefficiency and confusion in the blood collection process.

Many community blood banks trace their formation back to an era when glass jars were used for collection and modified milk trucks made deliveries. Therefore, each community blood bank could only serve its local community. The development of plastic blood bags and the establishment of rapid delivery services provided an opportunity to expand the radius of service. However, very few community blood banks have taken advantage of these new developments. This results in significant waste of blood products.

There is risk to holding excess inventory of blood. Blood has a shelf life of 42 days, and there is a very limited research market for blood older than 42 days. Of the approximately 15 million units of red blood cells collected from volunteer donors each year, approximately 500,000 units (62,000 gallons) are discarded due to expiration, representing approximately $150 million worth of wasted product. Waste of blood products is, therefore, a significant public health concern. More often than not, these units could be utilized in other parts of the country or for hematology research. However, the market lacks an efficient, transparent marketplace to connect excess supply to areas in need.

Even though some doctors believe that more recently donated blood results in fewer medical complications, blood banks do not price their products on “freshness.” In other words, a unit of blood that has 40 days of useful life is priced the same as a unit that has 10 days of useful life. There is some support for the idea that the aging of blood can pose human health impacts and specifically can affect biochemical performance and properties. Morbidity rates of various health conditions are affected by age of blood used with patients. Red blood cells out of the body are like fish out of water; every second they are out of their natural state they are dying and their oxygen and iron carrying capacity decreases.

Some additional reasons for the amount of wasted blood include: lack of price competition between suppliers; hospital blood committees lack meaningful tools to benchmark blood product usage against competing hospitals leaving system level CFOs powerless to compare performance among their hospitals; lab directors order blood daily (or more often) by phone and fax, which is an error-prone, time consuming process that often triggers stat fees and other add-on fees that could easily be avoided if there were more robust inventory controls; hospitals are often in a position to receive a fraction of products ordered resulting in cancelled surgeries and lost revenue; more valuable units (O negative) are priced the same as less desirable units (AB positive), which means blood centers receive no additional motivation or compensation for recruiting valuable donors and, therefore, hospitals have to barter to get the valuable units they require; there is an inability to track and transfer blood where it is needed most, which leads to waste.

### BRIEF SUMMARY OF THE INVENTION

The system disclosed herein provides a “virtual cooler” of blood from particular geographic regions, which then can be sold to hospitals in higher cost/lower supply markets. The system, in one embodiment, does not require physical possession of the products; all items are shipped using FDA-prescribed procedures from an FDA Licensed facility directly to another FDA Licensed facility.

The system uses an online e-commerce platform, which enables lab managers to transition away from phone and fax ordering to a web interface, saving time and reducing errors. This online ordering system also enables blood banks to post supply that is available on an ad hoc basis; lumpy supply never equals lumpy demand.

The system can also include full integration of blood bank supply and hospital demand. Blood suppliers and hospitals will interact on this platform to enter into long-term delivery (future) contracts as well as immediate (ad hoc) needs. The system can be both a financial clearinghouse and the logistics platform—collecting payments and generating shipping documents with complete transparency and certainty for both parties. Blood banks and hospitals will be able to manage their entire supply chain with the platform. This system can be priced similarly to other exchanges with members paying a tiered annual seat fee as well as per transaction fees. Subscribers will include blood centers, hospitals, health insurers, and governments. Use of the system is not limited to blood. For example, other biologics, such as skin, bone marrow, tissue, phenotyped units, organs, reagents, stem cells, breast milk and other perishable pharmaceuticals can be used on the exchange.

In addition, the system can provide disaster controls whereby blood supplies can be allocated based on emergency need rather than mere customer order. This could include cloud-based automated management in the event of a natural disaster, allowing for orderly blood orders and shipments.

### BRIEF DESCRIPTION OF THE DRAWINGS

FIG. 1 is a flowchart depicting one embodiment of an example ordering system.

FIG. 2 is an example graphical user interface showing blood platelet purchase availability according to one embodiment of the present invention.

FIG. 3 is a flowchart depicting an example offer transaction order state according to one embodiment of the present invention.

FIG. 4 is an illustration of an example of the shipment portion of an example system according to one embodiment of the present invention.

FIG. 5 is an illustration of an enhanced shipping label system used in accordance with one embodiment of the present invention.

FIG. 6 is a flowchart depicting an example of order an inventory information reporting to blood centers, according to one embodiment of the present invention.

FIG. 7 is an example of a report according to one embodiment of the present invention.

FIG. 8 is an overview of the blood-related transactions delivered by an example system according to one embodiment of the present invention.

FIG. 9 is a flow chart illustrating the admin process for pricing management according to one embodiment of the present invention.

FIG. 10 is a diagram illustrating an example process workflow for blood quote management according to one embodiment of the present invention.

FIG. 11 is an illustration of an example of phenotyping of blood units according to one embodiment of the present invention.

FIG. 12 is a schematic block diagram depicting an example computing system used in accordance with one embodiment of the present invention.

### DETAILED DESCRIPTION

Various user interfaces and embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims. It is understood that various omissions and substitutions of equivalents are contemplated as circumstances may suggest or render expedient, but these are intended to cover application or embodiments without departing from the spirit or scope of the claims attached hereto. Also, it is to be understood that the phraseology and terminology used herein are for the purpose of description and should not be regarded as limiting.

As noted above, one embodiment of the system disclosed herein provides a “virtual cooler” of blood from particular geographic regions that can then be sold to hospitals in higher cost/lower supply markets. The system does not require physical possession of the products; all items are preferably shipped, using FDA-prescribed procedures, from source to delivery destination. Users/subscribers will include blood centers, hospitals or other healthcare institutions, health insurers, and governments.

The system uses an online platform, which enables lab managers to transition away from phone and fax ordering to a web interface, saving time and reducing errors. This online ordering system also enables blood banks to post supply that is available on an ad hoc basis.

FIG. 1 depicts one embodiment of an example ordering system as disclosed herein. As shown, the system allows a healthcare institution to review availability of different types of blood and then place an order 102. A user can manually request inventory from a specific blood center after comparing pricing and location proximity of many blood centers. Alternatively, the system can automatically determine which blood center the order will be requested from by comparing proximity to the receiving location and available pricing 104. This allows for optimization of delivery time and cost. Thereafter, the blood is shipped from the chosen blood center to the healthcare institution 106. In one embodiment, the system could suggest blood orders (e.g., volume or type) based on past user orders or buying trends within the system.

FIG. 2 is an example order interface showing blood platelet purchase availability. In this example, the potential buyer can see potential purchase options with details on categories such as, but not limited to, blood type 202, expiration date 204, quantity of units available 206, and current price 208. For example, one potential purchase option may have the specific combination of type O blood, expires Tuesday, 33 units available, and price starting at $200. A potential buyer can also view inventory details 210 for each purchase option and the number of units in the buyer's cart. Inventory details may include additional phenotyping information or variations in prices and quantities at each price for a combination of type O blood that expires Tuesday. When a potential buyer makes a selection, he or she can select an “add to cart” button 212.

Because of the sensitivity of the material being sold and transported, it is essential to allow a seller to post, review, revise and approve offers before being made available to potential buyers. FIG. 3 depicts an example offer transaction order state 300. The high-level steps include: (a) the blood center creates a draft offer; (b) the blood center may revise the offer or complete submission; (c) once finalized and approved by the blood center, the offer is posted live. In another embodiment, the system admin could also have mandatory review and approval of offers. This embodiment could allow the system to track the type, quantity and quality of orders to avoid potential errors. For example, the system could detect and prevent offers that involve unusual volumes of blood or unusual volumes of rare blood types. The steps from creation of offer to delivery of order are displayed.

The steps associated with offers can include the following: the blood center creates the offer and posts it, the blood center makes pre-markup changes and applies them to the offer, the offer has the status of approval pending, an administrator approves the offer, and the offer goes live. If edits need to be made after the offer is live, the blood center can create them and save them into a pre-markup form. Thereafter, the changes can be applied, require approval, and be posted live after an administrator approves the changes to the offer.

The steps associated with a transaction can include the following: a hospital selects the product it needs, the transaction is pending, a purchase is made, and the transaction is complete. In one embodiment, the live offer can be optimistically decremented to increase the number of potential purchases. In one embodiment, edits a hospital makes to the transaction can modify the live offer available product counts. In another embodiment, when a transaction is pending, it can be canceled or timed out and then the offer will be rolled back to a live offer. In another embodiment, after a purchase has been made, the transaction is marked as final and that final status is reflected in the available live offers.

The steps associated with an order/shipment can include the following: the system creates the order and notifies the hospital and the system creates the shipment and notifies the blood center that it needs to make a shipment to the hospital that purchased the offer.

FIG. 4 depicts the shipment portion of an example system. The system can provide an application programming interface (API) 402 that allows for rapid and neutral calculation of shipping costs. The system calculation of pricing can reflect factors, such as, but not limited to geography and stat shipping requests, which are requests for high priority orders, frequently dealing with life-threatening situations. For example, the software can alert a hospital as to which blood centers are in its area that have inventory to ship and whether, as illustrated in FIG. 4, the hospital 404 is within a free shipping radius 406 of an available blood center 408 or if it is a radius that requires the hospital 404 to pay for shipping 410. Further, the system can collect and evaluate weather data from UPS, Federal Express or other delivery services that could impact delivery time. Where this delivery time would impact blood freshness, the system could identify the extent of the impact and modify or cancel the order.

Optimally, the system can use an enhanced shipping label system referred to as ISBT 128, as illustrated in FIG. 5, in lieu of the standard Codabar, also illustrated in FIG. 5. The advantage of ISBT 128 is increased bandwidth to be able to scan all relevant information about the unit of blood. Information included in the shipping label can include, but is not limited to, ABO type 502, Rh factor 504, expiration date 506, the unit's identification number 508, product description 510, and additional antigens either present or not present in the unit. Product description 510 can include information such as, but not limited to, the type of blood product being shipped (for example, red blood cells) and whether any additional products, such as saline, have been added to the blood product.

In addition to facilitating individual transactions, the system can also include full integration of blood bank supply and hospital demand. Blood suppliers and hospitals can interact on the platform to enter into long-term delivery (future) contracts as well as immediate (ad hoc) needs. The system can be a financial clearinghouse, a logistics platform, and a regulatory reporting tool to track down the individual unit number for recalls, “lookbacks,” and adverse events in that it can collect payments, generate shipping documents, and report back to the FDA when an “event” has occurred. Blood banks and hospitals will both be able to manage their entire supply chain with the platform. The system can be priced similarly to other exchanges with members paying a tiered annual seat fee as well as a per-transaction fee. Subscribers will include blood centers, hospitals or other healthcare institutions, health insurers, and governments. Use of the system is not limited to blood. For example, other biologics, such as skin, bone marrow, tissue, phenotyped units, organs, reagents, stem cells, breast milk and perishable pharmaceuticals could also be made available on the exchange.

Another aspect of the system disclosed herein is inventory data process. The system can access the inventory data of the community blood banks through intelligent software that exports inventory data into a database. Examples of blood inventory management software include Blood Bank Control System from Blood Bank Computer Systems Inc., PathNet from Cerner Corp., and IDM Select Series for Blood Centers from Information Data Management, Inc. and SafeTrace from Haemonetics. With the collected data, the system can offer analytics to uncover meaningful trends in the inventory data. For example, the system can determine which facilities are using more blood than other comparable facilities and enable them to get guidance on where they stand among their peers. Ideally, the system can predict inventory patterns and present opportunities to take advantage of excesses and shortages in the market. It can report this information, in real time, back to blood centers and hospitals so that donor recruitment efforts more can be matched up more accurately with real time hospital demand in regard to volume needed and ABO/Rh type.

The system can also allow for rich data analysis, including donor trends, inventory trends, buying trends, location-based analysis, and effect of socio-economic variances on access to fresh blood among many other categories, including others described above.

Additionally, the system will allow for standardized payment. Currently, shipments of blood are sent out every day, blood centers invoice on their own schedules, and packing slips that have the units' numbers required (under FDA mandate) for entry into the disclosed system do not come in on time. For example, if blood is shipped 30 days in a row, an invoice is received by the system for these shipments. However, the packing slips received at hospitals fall by the wayside because hospitals have not historically kept them since they have been tethered to a single blood center for the last 60 years. Further, blood centers are not used to providing the disclosed system with the unit number information. Therefore, hospitals usually pay the invoice, and blood centers rarely, if ever, send the packing slips. Because the FDA requires invoices paid through the system to include packing slips, the system can resolve the above-identified problem by hosting a settlement period of three days. Therefore, after orders are shipped, hospitals can have three days to pay invoices and the system can settle with blood centers. This information then can be aggregated and given to the hospital executives to determine if processes need to be changed. For example, if a lab director is routinely incurring stat fees, the hospital executive can coach them to plan further in advance to avoid stat fees.

FIG. 6 depicts how information reporting to blood centers can create a more efficient blood supply and ordering system. For example, the blood supply management system 602 can report order and inventory information 604 to blood centers 606 such as, but not limited to, the following trend data: execution price, average price, and volume. With various available blood centers 606, this reporting can enable blood centers 606 to take actions 608 such as, but not limited to, adjusting pricing, volume of collections, and recruiting strategy. These actions 608 result in enhanced pricing and efficient blood volume recruitment and collection. In turn, blood freshness will increase, pricing will become more competitive, and waste will be prevented.

FIG. 7 illustrates a sample report for a blood center 700. The sample report 700 shows that the hospital did not receive as many blood units as it wanted for blood types O−, O+, and A−. Therefore, the sample report 700 shows a gap between demand and supply that could be addressed by blood centers using the networked system. For example, if a hospital ordered 35 total blood units but received only 25, as illustrated in FIG. 7, this gap presents an opportunity for blood centers to take action 608.

FIG. 8 is an overview of the blood-related transactions delivered by an example system 800. In this example system 800, blood inventory from suppliers 802 such as a community blood bank 804 or a region of the American Red Cross 806 is ordered and moves through an information system and network organized by the disclosed blood supply management system 808 to customers 810 such as health systems 812, independent hospitals 814, and healthcare institutions. To use the system, each supplier 802, such as a community blood bank 804, or the national American Red Cross organization 816, can contract to use the blood supply management system 808 to increase supply efficiency, and each customer 810, such as health systems 812 or independent hospitals 814, can contract to use the blood supply management system 808 to increase order efficiency.

FIG. 9 is a depiction of an admin process for pricing management. This figure illustrates how the disclosed system can give real time guidance to a blood center about pricing for a particular offering. The system, or an administrator, can make price quotes, save those price quotes, make edits and re-save, and submit the price quotes. Alternatively, the system, or an administrator, can review priced quotes, edit those price quotes, save, and submit them. When making edits or recommendations, the system or administrator can compare one blood center's pricing for a particular offering to another blood center's offering for a similar offering. For example, if the execution price for a 3-day old, type O platelet unit is $530 and a blood center is posting at $535 and unable to sell, the system can review the priced quotes at that blood center and others and advise the blood center that if it lowers its price to $530, it will likely get an execution. The blood center then has the opportunity to decide what it wants to do. It can either take the guidance or not. Additionally, it can use the information for longer term planning about where its platelet pricing needs to be in order to be competitive on a national level. Blood age and other factors can affect pricing dynamically. The disclosed system allows for a more efficient market, more rapid sales, and quicker transport of product.

FIG. 10 is a diagram of an example process workflow for blood quote management. In some embodiments, this process has been automated. As soon as a blood center posts its units, shipping is calculated, and those units are immediately available to be purchased by hospitals or other healthcare institutions. The price can be fully quoted and the order can be tracked in the order history tab.

As illustrated in FIG. 10, the quote processing workflow may include the following steps: a hospital user 1002 can request a quote from a server 1006 via web 1004; the server 1006 can compute a schedule and save the schedule; the hospital user 1002 can confirm the quote using the web 1004; the server 1006 can save the quote and then (1) alert the hospital user 1002 via email 1012 that the quote is being worked on, (2) alert the hospital user 1002 via web that the quote is being worked on, and (3) send an email 1014 to a blood supplier 1010 telling the supplier to view the quote request; the blood supplier 1010 can view the quote on the server 1006; the blood supplier 1010 can save the quote on the supplier's web interface 1008, which then saves it on the server 1006; the blood supplier 1010 can approve the quote on the web 1008, which then approves the quote on the server 1006; the approved quote can be sent to the hospital user 1002 via email 1012; the hospital user 1002 can view the prepared quote on the server 1006; the server 1006 can alert the blood supplier 1010 via email 1014 that the hospital user 1006 is reviewing the quote; the hospital user 1006 can accept the quote on the web 1004, which will finalize the quote on the server 1006; the hospital user 1002 can view a receipt on the web 1004; the server 1006 can send the customer purchase order to the blood supplier 1010 via email 1014; the blood supplier 1010 can look up the quote on the server 1006; and the blood supplier 1010 can look up the quote details on the web 1008.

In addition, by increasing the number of users, the system can guarantee freshness on products to reduce “stat” orders (i.e., high priority orders) and “expedited” fees, eliminate risk of canceled surgeries, and offer built-in supply chain redundancy. These features are all critical to time efficiency, cost efficiency and patient health.

In addition to blood product supply management, the system disclosed herein could address similar inventory, ordering, delivery and freshness problems that occur with other human biological products, such as, but not limited to, skin, tissue, phenotyped units, organs, reagents, stem cells, and breast milk.

FIG. 11 is an example of units that have additional phenotyping 1102. These are units that have been tested for additional attributes beyond ABO/Rh and are in demand for people with chronic blood disorders. Disclosure of additional phenotyping 1102 is very valuable to patients with chronic blood disorders. A “better match” (more letters) can improve the efficacy of a transfusion by, first, eliminating some risk of an adverse reaction to the transfusion and, second, reducing the frequency with which the patient may need another transfusion. Patients with chronic blood disorders, such as Sickle Cell Anemia, get up to 52 transfusions per year. Therefore, a better match should be administered any time it is possible in order to increase the efficacy of the transfusion and reduce the number of transfusions the patient will likely need. Additional benefits are that the patient will feel better for longer, there is a lower risk of an adverse transfusion related event, and there is reduced cost to the hospital resulting from fewer visits by the patient.

Due to blood centers' current lack of pricing discipline, they do not phenotyping tests very often. It is costly to run the tests and blood centers currently do not charge hospitals a premium for blood that has been tested. Therefore, the testing just costs the blood centers money, even though it improves patient care. The disclosed system can standardize frequency of testing by enabling Hood centers to “blame the market” for the higher priced phenotyped units. Hospitals will have to decide whether they are willing to pay for the higher priced phenotyped units or not. With ACO and penalties for readmission, hospitals can quickly determine if they should pay for phenotyped units to avoid seeing the same patients every week. Therefore, blood centers will have an economic incentive to do more testing on more units and people with chronic blood disorders will receive blood that is a “better match.”

In another embodiment, the system can provide disaster controls whereby blood supplies can be allocated based on emergency need rather than mere customer order. Donor recruitment efforts in unaffected areas can be initiated in real time to help areas that have been affected and are temporarily unable to recruit and collect blood for their own populations. The system can include cloud- and location-based automated management in the event of a natural disaster, allowing continued orderly blood orders and shipments. Through use of the system, government or private users can use the system to do scenario-planning in the event of various kinds of disasters or public emergencies.

One of the major causes of blood supply shortages is lack of blood donor engagement and activity. The blood centers that obtain supply are reliant on conventional public relations and recruitment methods. Less than five percent of people in the United States who are eligible to donate blood actually do so. This creates public health issues, contributes to national blood supply shortages, and increases the dependency on aging blood and a relatively small group of loyal donors. In one embodiment, the system described herein could analyze regional donor trends, blood center offer frequency, and healthcare provider purchasing activity in order to project potential blood shortages by location. To address lack of donor activity generally, as well as in specific regions, the system can offer location-based user accounts. These accounts can permit donors to track their own donations, obtain points and rewards, and respond to local, real-time requests for donations. Gamification of donations could help drive donor engagement and blood collection success.

In some embodiments, the system described herein uses a computing system to carry out the various functions described herein. FIG. 12 is a schematic block diagram of an example computing system 1200. The example computing system includes at least one computing device 1202. In some embodiments the computing system further includes a communication network 1204 and one or more additional computing devices 1206 (such as a server).

The computing device 1202 can be, for example, located in a blood bank or hospital or can be a computing device located in a user's home or other place of business. In some embodiments, computing device 1202 is a mobile device. The computing device 1202 can be a stand-alone computing device or a networked computing device that communicates with one or more other computing devices 1206 across a network 1204. The additional computing device(s) 1206 can be, for example, located remotely from the first computing device 1202, but configured for data communication with the first computing device 1202 across a network 1204.

In some examples, the computing devices 1202 and 1206 include at least one processor or processing unit 1208 and system memory 1212. The processor 1208 is a device configured to process a set of instructions. In some embodiments, system memory 1212 may be a component of processor 1208; in other embodiments system memory is separate from the processor. Depending on the exact configuration and type of computing device, the system memory 1212 may be volatile (such as RAM), non-volatile (such as ROM, flash memory, etc.) or some combination of the two. System memory 1212 typically includes an operating system 1218 suitable for controlling the operation of the computing device, such as the WINDOWS® operating systems from Microsoft Corporation of Redmond, Wash. or the OS X operating system, or a server, such as Windows SharePoint Server, also from Microsoft Corporation, or such as a Mac Mini with OS X. The system memory 1212 may also include one or more software applications 1214 and may include program data 1216.

The computing device may have additional features or functionality. For example, the device may also include additional data storage devices 1210 (removable and/or non-removable) such as, for example, magnetic disks, optical disks, or tape. Computer storage media 1210 may include volatile and nonvolatile, removable and non-removable media implemented in any method or technology for storage of information, such as computer readable instructions, data structures, program modules, or other data. System memory, removable storage, and non-removable storage are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device. An example of computer storage media is non-transitory media.

In some examples, one or more of the computing devices 1202, 1206 can be located in an establishment, such as a blood bank or hospital. In other examples, the computing device can be a personal computing device that is networked to allow the user to access and utilize the system disclosed herein from a remote location, such as in a user's home, office or other location. In some embodiments, the computing device 1202 is a smart phone tablet, laptop computer, personal digital assistant, or other mobile device. In some embodiments system operations and functions are stored as data instructions for a smart phone application. A network 1204 facilitates communication between the computing device 1202 and one or more servers, such as an additional computing device 1206 that hosts the system. The network 1204 may be a wide variety of different types of electronic communication networks. For example, the network may be a wide-area network, such as the Internet, a local-area network, a metropolitan-area network, or another type of electronic communication network. The network may include wired and/or wireless data links. A variety of communications protocols may be used in the network including, but not limited to, Wi-Fi, Ethernet, Transport Control Protocol (TCP), Internet Protocol (IP), Hypertext Transfer Protocol (HTTP), SOAP, remote procedure call protocols, and/or other types of communications protocols.

In some examples, the additional computing device 1206 is a Web server. In this example, the first computing device 1202 includes a Web browser that communicates with the Web server to request and retrieve data. The data is then displayed to the user, such as by using a Web browser software application. In some embodiments, the various operations, methods, and functions disclosed herein are implemented by instructions stored in memory. When the instructions are executed by the processor of the one or more computing devices 1202 or 1206, the instructions cause the processor to perform one or more of the operations or methods disclosed herein. Examples of operations include the operations of blood inventory management, ordering and delivery, among others.

The various embodiments described above are provided by way of illustration only and should not be construed to limit the claims attached hereto. Those skilled in the art will readily recognize various modifications and changes that may be made without following the example embodiments and applications illustrated and described herein and without departing from the true spirit and scope of the following claims.

We claim:

1. A method of managing a blood supply inventory system with buyers and sellers comprising:
utilizing a networked computing device having a processing device and a memory device, the memory device storing information that, when executed by the processing device, causes the processing device to:
obtain information from a seller about blood supply in the seller's possession wherein the information about blood supply includes blood type and quantity;
obtain from a seller a price at which the seller is willing to sell at least one unit of the seller's blood supply;
obtain from a buyer a blood type and blood quantity sought by the buyer;
provide the buyer the blood supply and price information from the seller.

2. The method of claim 1, wherein the buyer has the option of purchasing at least one unit of the blood supply in the seller's possession.

3. The method of claim 1, wherein the seller provides information about the location of seller's blood supply.

4. The method of claim 3, wherein the buyer may search for blood supply based on the location of the blood supply.

5. The method of claim 1, wherein the processing device can obtain information from a seller about the blood's age.

6. The method of claim 5, wherein the processing device compares one seller's blood supply information to another seller's blood supply information and advises the first seller to change the price at which it is selling at least one unit of blood.

7. The method of claim 1, wherein the processing device can also obtain information from a seller about the number of units available for a specific type of blood at a specific price.

8. The method of claim 1, wherein the processing device can also obtain information from a seller about phenotype information of a specific unit of blood.
